(19) United States
(12) Patent Application Publication
(10) Pub. No.: US 2026/0127972 A1
(43) Pub. Date: May 7, 2026

(54) METHOD OF PREDICTING TEST PASS/FAIL USING LIMITED NUMBER OF QUESTIONS AND PREDICTION SYSTEM PERFORMING THE SAME

(71) Applicant: THE AI LAB, INC., Seoul (KR)

(72) Inventors: Yafeng DENG, Beijing (CN); Young-June CHOI, Seoul (KR)

(21) Appl. No.: 19/378,244

(22) Filed: Nov. 3, 2025

(30) Foreign Application Priority Data
Nov. 4, 2024 (KR) 10-2024-0154020

(51) Int. Cl. G09B 7/00; G06N 7/01

(52) U.S. Cl. CPC G09B 7/00; G06N 7/01

(57) ABSTRACT

In a method of predicting test pass/fail, first user portrait data of first users who passed a target test and second user portrait data of second users who failed the target test are obtained. M reference questions are selected from among first to Nth questions included in the target test. Response data representing whether answers of a target user for the M reference questions are correct or incorrect is collected. First conditional probability and second conditional probability are calculated by performing Bayesian inference based on the first user portrait data, the second user portrait data and the response data. Prediction result is generated based on the first conditional probability and the second conditional probability.

### CROSS-REFERENCE TO RELATED APPLICATION

This application claims priority under 35 USC § 119 to Korean Patent Application No. 10-2024-0154020 filed on Nov. 4, 2024 in the Korean Intellectual Property Office (KIPO), the contents of which are herein incorporated by reference in their entirety.

### BACKGROUND

### 1. Technical Field

Example embodiments relate generally to a technique for predicting test pass/fail, and more particularly to methods of predicting test pass/fail using limited number of questions, and prediction systems performing the methods of predicting test pass/fail.

### 2. Description of the Related Art

As information and communication technology (ICT) has developed and database management has become easier using computers, learning information may be stored in databases, and various related services may be provided with various contents.

National tests, such as certification tests, are crucial for users taking them. When preparing for such tests, users may have limited access to methods and opportunities to predict whether they will pass or fail, and this may be time-consuming.

For example, it may be predicted whether users will pass or fail an actual test by taking a pretest similar to the actual test. The pretest may include a similar number of questions as that of the actual test, allowing users to check how high their scores are likely to be. However, there may be problems that it takes a significant amount of time for users to solve a large number of questions included in the pretest and it is difficult to prepare a large number of questions for the pretest.

### SUMMARY

At least one example embodiment of the present disclosure provides a method of predicting test pass/fail capable of efficiently predicting pass or fail of a test with a relatively small number of questions based on Bayesian inference.

At least one example embodiment of the present disclosure provides a prediction system performing the method of predicting test pass/fail.

According to example embodiments, in a method of predicting test pass/fail, the method is performed by executing instructions using a processor, and the instructions are stored in a non-transitory computer-readable medium. For a target test including first to Nth questions, first user portrait data of first users who passed the target test and second user portrait data of second users who failed the target test are obtained, where N is a positive integer greater than or equal to two. The first user portrait data represents first-first to Nth-first correct rates of the first users for the first to Nth questions. The second user portrait data represents first-second to Nth-second correct rates of the second users for the first to Nth questions. M reference questions are selected from among the first to Nth questions, where M is a positive integer less than N. Response data representing whether answers of a target user for the M reference questions are correct or incorrect is collected. The target user is a user who wants to check whether will pass or fail the target test. First conditional probability and second conditional probability are calculated by performing Bayesian inference based on the first user portrait data, the second user portrait data and the response data. The first conditional probability represents probability that the target user passes the target test based on the response data being collected. The second conditional probability represents probability that the target user fails the target test based on the response data being collected. Prediction result is generated based on the first conditional probability and the second conditional probability. The prediction result represents whether the target user will pass or fail the target test. The first conditional probability and the second conditional probability are obtained based on Equation 1 and Equation 2, respectively.

$$P ( A \vert E ) = P ( E \vert A ) * P ( A ) / P ( E ) \qquad [ Equation 1 ]$$

$$P ( B \vert E ) = P ( E \vert B ) * P ( B ) / P ( E ) \qquad [ Equation 2 ]$$

In Equations 1 and 2, P(A|E) denotes the first conditional probability, P(B|E) denotes the second conditional probability, P(A) denotes probability that pass event occurs in the target test, P(B) denotes probability that fail event occurs in the target test, P(E) denotes probability that the response data occurs, P(E|A) denotes conditional probability that the response data occurs based on the pass event occurring, and P(E|B) denotes conditional probability that the response data occurs based on the fail event occurring.

According to example embodiments, a prediction system includes a processor and a non-transitory computer-readable medium. The non-transitory computer-readable medium stores instructions executed using the processor to predict test pass/fail. The processor obtains, for a target test including first to Nth questions, first user portrait data of first users who passed the target test and second user portrait data of second users who failed the target test, where N is a positive integer greater than or equal to two, selects M reference questions from among the first to Nth questions, where M is a positive integer less than N, collects response data representing whether answers of a target user for the M reference questions are correct or incorrect, calculates first conditional probability and second conditional probability by performing Bayesian inference based on the first user portrait data, the second user portrait data and the response data, and generates prediction result based on the first conditional probability and the second conditional probability. The first user portrait data represents first-first to Nth-first correct rates of the first users for the first to Nth questions. The second user portrait data represents first-second to Nth-second correct rates of the second users for the first to Nth questions. The target user is a user who wants to check whether will pass or fail the target test. The first conditional probability represents probability that the target user passes the target test based on the response data being collected. The second conditional probability represents probability that the target user fails the target test based on the response data being collected. The prediction result represents whether the target user will pass or fail the target test. The first conditional probability and the second conditional probability are obtained based on Equation 3 and Equation 4, respectively.

$$P ( A \vert E ) = P ( E \vert A ) * P ( A ) / P ( E ) \qquad [ Equation 3 ]$$

$$P ( B \vert E ) = P ( E \vert B ) * P ( B ) / P ( E ) \qquad [ Equation 4 ]$$

In Equations 3 and 4, P(A|E) denotes the first conditional probability, P(B|E) denotes the second conditional probability, P(A) denotes probability that pass event occurs in the target test, P(B) denotes probability that fail event occurs in the target test, P(E) denotes probability that the response data occurs, P(E|A) denotes conditional probability that the response data occurs based on the pass event occurring, and P(E|B) denotes conditional probability that the response data occurs based on the fail event occurring.

In the method of predicting test pass/fail and the prediction system according to example embodiments, various user portraits may be identified or recognized using the historical test records of the other users, and it may be predicted, using Bayesian inference, whether the target user will pass or fail the target test with a limited number (e.g., three or more) of questions. The accuracy of prediction may increase as the number of used questions increases, and the pass probability may also be provided. Accordingly, it may efficiently predict and provide information on whether the target user will pass or fail the target test, using relatively small amount of information.

### BRIEF DESCRIPTION OF THE DRAWINGS

Illustrative, non-limiting example embodiments will be more clearly understood from the following detailed description taken in conjunction with the accompanying drawings.

FIG. 1 is a flowchart illustrating a method of predicting test pass/fail according to example embodiments.

FIGS. 2 and 3 are block diagrams illustrating a prediction system according to example embodiments.

FIGS. 4, 5 and 6 are diagrams for describing a method of predicting test pass/fail according to example embodiments.

FIG. 7 is a flowchart illustrating an example of generating prediction result of FIG. 1.

### DETAILED DESCRIPTION OF THE EMBODIMENTS

Various example embodiments will be described more fully with reference to the accompanying drawings, in which embodiments are shown. The present disclosure may, however, be embodied in many different forms and should not be construed as limited to the embodiments set forth herein. Like reference numerals refer to like elements throughout this application.

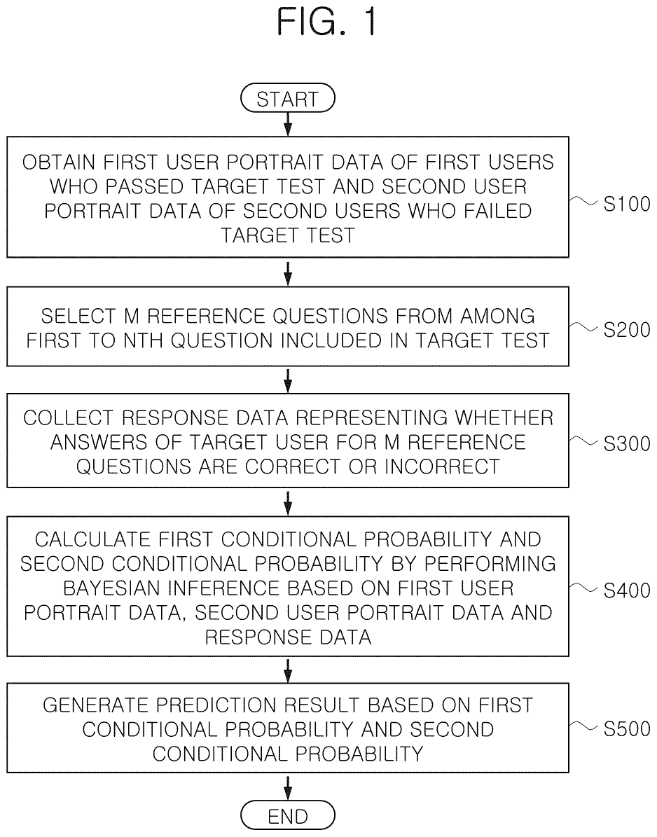

FIG. 1 is a flowchart illustrating a method of predicting test pass/fail according to example embodiments.

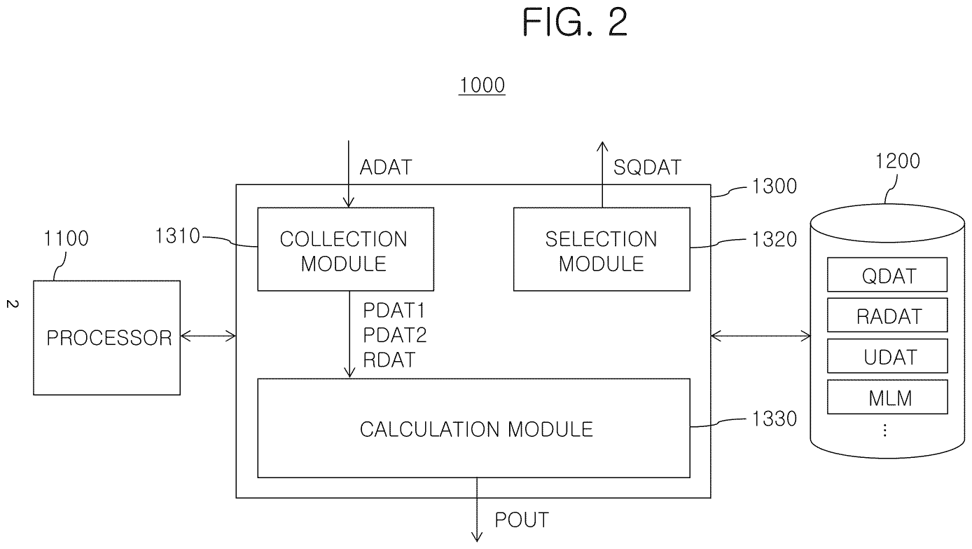

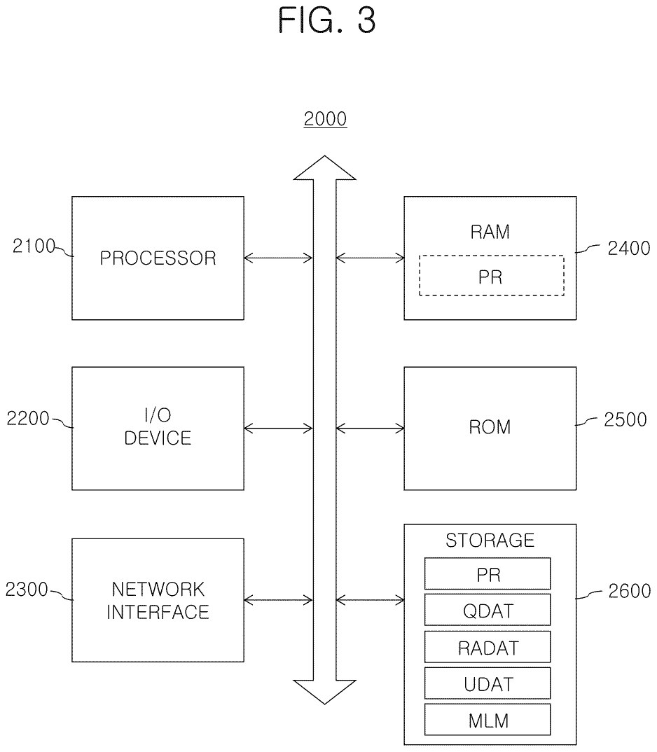

Referring to FIG. 1, a method of predicting test pass/fail according to example embodiments may be performed on a computer-based system and/or tool, at least part of which is implemented in hardware and/or software. For example, the system and/or tool may include program (or software) that includes a plurality of instructions executed using at least one processor. The system and/or tool will be described with reference to FIGS. 2 and 3.

In the method of predicting test pass/fail according to example embodiments, for a target test including first to Nth questions, first user portrait data of first users who passed the target test and second user portrait data of second users who failed the target test are obtained, where N is a positive integer greater than or equal to two (operation S100). The first user portrait data represents first-first to Nth-first correct rates of the first users for the first to Nth questions. The second user portrait data represents first-second to Nth-second correct rates of the second users for the first to Nth questions.

User portrait, also known as user persona, is the process of tag modeling based on massive user information data. In detail implementation, user portrait may be represented as a set of tags that describe user's characteristics. This set of tags may include tags that describe the user's characteristics from various perspectives, such as social attributes, lifestyle habits and consumption behavior. For example, tags may include age, gender, region, education level, user preferences, etc.

In some example embodiments, historical test records of other users for the target test and related information (e.g., test scores, whether each question was correctly answered, etc.) may be used as user portraits. For example, the users may be classified into two groups based on the test scores for the target test, correct rate information of the first users with relatively high test scores may be obtained as the first user portrait data, and correct rate information of the second users with relatively low test scores may be obtained as the second user portrait data. For example, the first users may represent users who passed the target test because their test scores were higher than or equal to a reference score, and the second users may represent users who failed the target test because their test scores were lower than the reference score.

M reference questions are selected from among the first to Nth questions, where M is a positive integer less than N (operation S200). In some example embodiments, the M reference questions may be randomly selected from among the first to Nth questions. In some example embodiments, the M reference questions may be designated in advance and may be selected from among the first to Nth questions. For example, the M reference questions may be designated based on the historical test records of the other users.

Response data representing whether answers of a target user for the M reference questions are correct or incorrect is collected (operation S300). The target user may be a user who wants to check whether will pass or fail the target test. In some example embodiments, the target user may be different from all of the first and second users, or may be one of the first and second users. For example, the response data may represent whether the target user answered each of the M reference questions correctly or incorrectly.

First conditional probability and second conditional probability are calculated by performing Bayesian inference based on the first user portrait data, the second user portrait data and the response data (operation S400). The first conditional probability represents probability that the target user passes the target test based on the response data being collected. The second conditional probability represents probability that the target user fails the target test based on the response data being collected. For example, the Bayesian inference may be performed using a machine learning model. The process of calculating the first and second conditional probabilities will be described later.

Bayesian inference, also known as Bayes inference, is a method of statistical inference in which Bayes' theorem is used to update a probability of hypothesis after obtaining additional information through experiments. Bayesian inference is applied to dynamically analyzing a sequence of data to adapt to given conditions, and more recently, it has been used in the field of artificial intelligence (AI) to update knowledge learned from prior data with additional data to suit specific conditions. For example, Bayesian inference may be performed based on Equation 1.

$$P ( H \vert E ) = P ( E \vert H ) * P ( H ) / P ( E ) \qquad [ Equation 1 ]$$

In Equation 1, H denotes proposition, and for example, may represent that a specific event occurs. P(H) denotes prior probability or hypothesis, and for example, may represent a value assigned as probability representing the “degree of belief” in the proposition H. E denotes evidence or new data to be considered, and P(E) denotes probability, which is obtained by measurement, that the evidence E occurs. P(E|H) denotes likelihood function, and for example, may represent conditional probability that the evidence E occurs when the proposition H is established. P(H|E), which is calculated using P(E|H), P(H) and P(E), denotes posterior probability, and for example, may represent probability of the proposition H after the evidence E has been observed (or after considering the evidence E). For example, P(H|E) may be interpreted as the “changed degree of belief” after observing the evidence. Typically, P(H) may be updated after considering new evidence. Such updating process may be referred to as Bayesian updating.

In other words, before observing data, there may be belief related to the proposition H based on prior knowledge. This belief may not be fixed and may be updated as the evidence E related to the event increases. Bayesian inference may be used to infer the posterior probability distribution from the prior probability distribution and the likelihood function.

Prediction result is generated based on the first conditional probability and the second conditional probability (operation S500). The prediction result represents whether the target user will pass or fail the target test. For example, the prediction result may include information whether the target user will pass or fail the target test. For example, the prediction result may further include pass probability and/or fail probability.

Although FIG. 1 illustrates that operations S100, S200, S300, S400 and S500 are sequentially performed, example embodiments are not limited thereto, and at least some of operations S100, S200, S300, S400 and S500 may be substantially simultaneously performed.

FIGS. 2 and 3 are block diagrams illustrating a prediction system according to example embodiments.

Referring to FIG. 2, a prediction system 1000 includes a processor 1100, a database 1200 and a prediction module 1300.

Herein, the term “module” may indicate, but is not limited to, a software and/or hardware component, such as a field programmable gate array (FPGA) or an application specific integrated circuit (ASIC), which performs certain tasks. A “module” may be configured to reside in a tangible addressable storage medium and be configured to execute on one or more processors. For example, a “module” may include components such as software components, object-oriented software components, class components and task components, and processes, functions, routines, segments of program code, drivers, firmware, microcode, circuitry, data, databases, data structures, tables, arrays, and variables. A “module” may be divided into a plurality of “modules” that perform detailed functions.

The processor 1100 may be used to control an operation of the prediction system 1000 and may be used when the prediction module 1300 performs computations or calculations. For example, the processor 1100 may include a microprocessor, an application processor (AP), a central processing unit (CPU), a digital signal processor (DSP), a graphic processing unit (GPU), a neural processing unit (NPU), or the like.

The database 1200 may store data used for the operation of the prediction system 1000. For example, the database 1200 may store question data QDAT including the first to Nth questions included in the target test, right answer data RADAT including first to Nth right answer values for the first to Nth questions, user data UDAT including the historical test records of the other users who took the target test and solved the first to Nth questions, and may also include various other related data. For example, the database 1200 may store data related to a machine learning model MLM for performing Bayesian inference.

In some example embodiments, the database 1200 may include an arbitrary non-transitory computer-readable storage medium (or device) used to provide commands and/or data to a computer. For example, the non-transitory computer-readable storage medium may include a volatile memory such as a static random access memory (SRAM), a dynamic random access memory (DRAM), or the like, and a nonvolatile memory such as a flash memory, a magnetic random access memory (MRAM), a phase-change random access memory (PRAM), a resistive random access memory (RRAM), a ferroelectric random access memory (FRAM), or the like. The non-transitory computer-readable storage medium may be inserted into the computer, may be integrated in the computer, or may be coupled to the computer through a communication medium such as a network and/or a wireless link.

The prediction module 1300 may perform the method of predicting test pass/fail according to example embodiments described with reference to FIG. 1. The prediction module 1300 may include a collection module 1310, a selection module 1320 and a calculation module 1330.

The collection module 1310 receives the question data QDAT, the right answer data RADAT and the user data UDAT from the database 1200. Based on the question data QDAT, the right answer data RADAT and the user data UDAT, the collection module 1310 obtains first user portrait data PDAT1 of the first users who passed the target test and second user portrait data PDAT2 of the second users who failed the target test. In other words, the collection module 1310 may perform operation S100 of FIG. 1.

The selection module 1320 selects the M reference questions from among the first to Nth questions included in the question data QDAT, and generates selected question data SQDAT including the M reference questions. The selection module 1320 provides the selected question data SQDAT to the target user who wants to check whether will pass or fail the target test. In other words, the selection module 1320 may perform operation S200 of FIG. 1.

The collection module 1310 receives answer data ADAT including results of solving, by the target user, the M reference questions included in the selected question data SQDAT. Based on the answer data ADAT and the right answer data RADAT, the collection module 1310 collects response data RDAT representing whether the target user answered the M reference questions correctly or incorrectly. In other words, the collection module 1310 may perform operation S300 of FIG. 1.

The calculation module 1330 receives the first user portrait data PDAT1, the second user portrait data PDAT2 and the response data RDAT from the collection module 1310. Based on the first user portrait data PDAT1, the second user portrait data PDAT2 and the response data RDAT, the calculation module 1330 calculates the first conditional probability representing probability that the target user passes the target test based on the response data RDAT being collected, and calculates the second conditional probability representing probability that the target user fails the target test based on the response data RDAT being collected. Based on the first conditional probability and the second conditional probability, the calculation module 1330 generates prediction result POUT representing whether the target user will pass or fail the target test. In other words, the calculation module 1330 may perform operations S400 and S500 of FIG. 1.

In some example embodiments, the collection module 1310, the selection module 1320 and the calculation module 1330 may be implemented as instructions or program codes that may be executed by the processor 1100. In other example embodiments, the processor 1100 may be manufactured to efficiently execute instructions or program codes included in the collection module 1310, the selection module 1320 and the calculation module 1330.

In some example embodiments, the collection module 1310, the selection module 1320 and the calculation module 1330 may be implemented as a single integrated module. In other example embodiments, the collection module 1310, the selection module 1320 and the calculation module 1330 may be implemented as separate and different modules

Referring to FIG. 3, a prediction system 2000 includes a processor 2100, an input/output (I/O) device 2200, a network interface 2300, a random access memory (RAM) 2400, a read only memory (ROM) 2500 and a storage device 2600. FIG. 3 illustrates an example where all of the collection module 1310, the selection module 1320 and the calculation module 1330 of FIG. 2 are implemented in software.

The processor 2100 may be substantially the same as the processor 1100 of FIG. 2. For example, the processor 2100 may access a memory (e.g., the RAM 2400 or the ROM 2500) through a bus, and may execute instructions stored in the RAM 2400 or the ROM 2500. As illustrated in FIG. 3, the RAM 2400 may store a program PR corresponding to the collection module 1310, the selection module 1320 and the calculation module 1330 of FIG. 2 or at least some elements of the program PR, and the program PR may allow the processor 2100 to perform operations for predicting test pass/fail (e.g., operations S100, S200, S300, S400 and S500 of FIG. 1).

The storage device 2600 may store the program PR. The program PR or at least some elements of the program PR may be loaded from the storage device 2600 to the RAM 2400 before being executed by the processor 2100. The storage device 2600 may store a file written in a program language, and the program PR generated by a compiler or the like or at least some elements of the program PR may be loaded to the RAM 2400.

In addition, the storage device 2600 may store the question data QDAT, the right answer data RADAT, the user data UDAT and the data related to the machine learning model MLM. In other words, the storage device 2600 may function as the database 1200 of FIG. 2.

The I/O device 2200 may include an input device, such as a keyboard, a pointing device, or the like, and may include an output device such as a display device, a printer, or the like. For example, a user may trigger, through the I/O devices 2200, execution of the program PR by the processor 2100, and may provide or check various inputs, outputs and/or data, etc.

The network interface 2300 may provide access to a network outside the prediction system 2000. For example, the network may include a plurality of computing systems and communication links, and the communication links may include wired links, optical links, wireless links, or arbitrary other type links. Various inputs may be provided to the prediction system 2000 through the network interface 2300, and various outputs may be provided to another computing system through the network interface 2300.

In some example embodiments, the computer program codes and the prediction module 1300 may be stored in a transitory or non-transitory computer-readable medium. In some example embodiments, various intermediate data and/or result data obtained from arithmetic processing performed by the processor may be stored in a transitory or non-transitory computer-readable medium. However, example embodiments are not limited thereto.

In some example embodiments, the prediction system 1000 and 2000 of FIGS. 2 and 3 may be implemented in the form of various electronic systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, an automotive, etc.

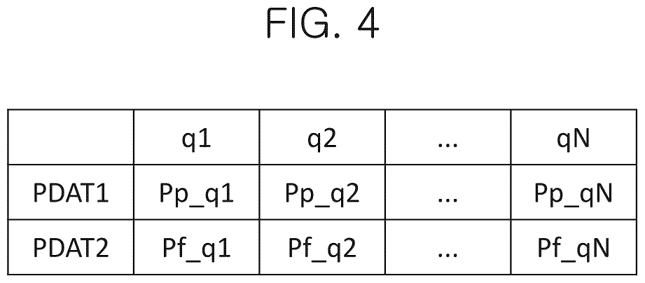

FIGS. 4, 5 and 6 are diagrams for describing a method of predicting test pass/fail according to example embodiments.

Referring to FIG. 4, an example of the first user portrait data PDAT1 and the second user portrait data PDAT2 that are obtained in operation S100 of FIG. 1 is illustrated.

The target test may include a first question q1, a second question q2, . . . , and an Nth question qN. In some example embodiments, q1, q2, . . . , qN may represent question identifications (IDs) for each question.

The first user portrait data PDAT1 may include a first-first correct rate Pp_q1 of the first users who answered the first question q1, a second-first correct rate Pp_q2 of the first users who answered the second question q2, . . . , and an Nth-first correct rate Pp_qN of the first users who answered the Nth question qN. For example, the first-first correct rate Pp_q1 may represent a value obtained by dividing the number of users who answered the first question q1 correctly among the first users by the total number of the first users. For example, each of the first-first correct rate Pp_q1 to the Nth-first correct rate Pp_qN may be a real number greater than or equal to zero and less than or equal to one.

The second user portrait data PDAT2 may include a first-second correct rate Pf_q1 of the second users who answered the first question q1, a second-second correct rate Pf_q2 of the second users who answered the second question q2, . . . , and an Nth-second correct rate Pf_qN of the second users who answered the Nth question qN. For example, the first-second correct rate Pf_q1 may represent a value obtained by dividing the number of users who answered the first question q1 correctly among the second users by the total number of the second users. For example, each of the first-second correct rate Pf_q1 to the Nth-second correct rate Pf_qN may be a real number greater than or equal to zero and less than or equal to one.

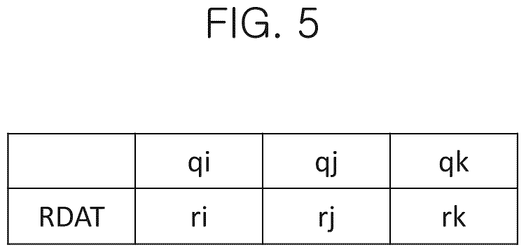

Referring to FIG. 5, an example of the response data RDAT that is obtained in operation S300 of FIG. 1 is illustrated.

In some example embodiments, in operation S200, three questions may be selected from among the first question q1 to the Nth question qN (e.g., M=3). For example, an ith question qi, a jth question qj and a kth question qk may be selected, where each of I, j and k is a positive integer greater than or equal to one and less than or equal to N. For example, i, j and k may be different integers.

The response data RDAT may include an ith response value ri representing whether the target user answered the ith question qi correctly, a jth response value rj representing whether the target user answered the jth question qj correctly, and a kth response value rk representing whether the target user answered the kth question qk correctly.

As described above, the response data RDAT may be obtained based on the right answer data RADAT of FIG. 2 and the answer data ADAT of FIG. 2.

In some example embodiments, when the target user answers the ith question qi correctly, e.g., when an ith answer value of the target user for the ith question qi is equal to (or matches) an ith right answer value for the ith question qi, the ith response value ri for the ith question qi included in the response data RDAT may have a first value. When the target user answers the ith question qi incorrectly, e.g., when the ith answer value is different from (or does not match) the ith right answer value, the ith response value ri may have a second value different from the first value. For example, the first value may be “1”, and the second value may be “0”.

Similarly, the jth response value rj may have the first value when the target user answers the jth question qj correctly, and the jth response value rj may have the second value when the target user answers the jth question qj incorrectly. The kth response value rk may have the first value when the target user answers the kth question qk correctly, and the kth response value rk may have the second value when the target user answers the kth question qk incorrectly.

In some example embodiments, the first conditional probability and the second conditional probability that are obtained in operation S400 may be obtained based on Equation 2 and Equation 3, respectively.

$$P ( A \vert E ) = P ( E \vert A ) * P ( A ) / P ( E ) \qquad [ Equation 2 ]$$

$$P ( B \vert E ) = P ( E \vert B ) * P ( B ) / P ( E ) \qquad [ Equation 3 ]$$

Equation 2 and Equation 3 may be obtained based on Bayesian inference of Equation 1. In Equation 2 and Equation 3, P(A|E) denotes the first conditional probability, P(B|E) denotes the second conditional probability, P(A) denotes probability that pass event occurs in the target test, P(B) denotes probability that fail event occurs in the target test, P(E) denotes probability that the response data RDAT occurs, P(E|A) denotes conditional probability that the response data RDAT occurs based on the pass event occurring, and P(E|B) denotes conditional probability that the response data RDAT occurs based on the fail event occurring.

In some example embodiments, if there is no prior information about users who take the target test, the probability that the pass event occurs and the probability that the fail event occurs may be equal to each other. Therefore, each of P(A) and P(B) included in Equation 2 and Equation 3 may be 0.5.

In some example embodiments, P(E) included in Equation 2 and Equation 3 may be a constant and may be obtained based on Equation 4.

$$P ( E ) = P ( E \vert A ) * P ( A ) + P ( E \vert B ) * P ( B ) \qquad [ Equation 4 ]$$

In some example embodiments, as illustrated in FIG. 5, when M is three and when the ith question qi, the jth question qj and the kth question qk are selected, P(E|A) included in the Equation 2 and Equation 4 may be calculated based on an ith-first correct rate for the ith question qi, a jth-first correct rate for the jth question qj and a kth-first correct rate for the kth question qk among the first-first correct rate Pp_q1 to Nth-first correct rates Pp_qN of FIG. 4. For example, P(E|A) may be calculated by multiplying an ith-first value determined based on the ith-first correct rate, a jth-first value determined based on the jth-first correct rate and a kth-first value determined based on the kth-first correct rate.

In addition, P(E|B) included in the Equation 3 and Equation 4 may be calculated based on an ith-second correct rate for the ith question qi, a jth-second correct rate for the jth question qj and a kth-second correct rate for the kth question qk among the first-second correct rate Pf_q1 to the Nth-second correct rate Pf_qN of FIG. 4. For example, P(E|B) may be calculated by multiplying a ith-second value determined based on the ith-second correct rate, a jth-second value determined based on the jth-second correct rate and a kth-second value determined based on the kth-second correct rate.

In some example embodiments, when the target user answers the ith question qi correctly, e.g., when the ith response value ri for the ith question qi has the first value (e.g., “1”), a value corresponding to the ith-first correct rate may be determined as the ith-first value. When the target user answers the ith question qi incorrectly, e.g., when the ith response value ri has the second value (e.g., “0”), a value obtained by subtracting the ith-first correct rate from one may be determined as the ith-first value.

Similarly, a value corresponding to the jth-first correct rate may be determined as the jth-first value when the jth response value rj for the jth question qj has the first value, and a value obtained by subtracting the jth-first correct rate from one may be determined as the jth-first value when the jth response value rj has the second value. A value corresponding to the kth-first correct rate may be determined as the kth-first value when the kth response value rk for the kth question qk has the first value, and a value obtained by subtracting the kth-first correct rate from one may be determined as the kth-first value when the kth response value rk has the second value.

Thereafter, P(E|A) may be calculated by multiplying the ith-first value, the jth-first value and the kth-first value.

Similarly, depending on whether the ith response value ri for the ith question qi is the first value or the second value, a value corresponding to the ith-second correct rate may be determined as the ith-second value, or a value obtained by subtracting the ith-second correct rate from one may be determined as the ith-second value. Depending on whether the jth response value rj for the jth question qj is the first value or the second value, a value corresponding to the jth-second correct rate may be determined as the jth-second value, or a value obtained by subtracting the jth-second correct rate from one may be determined as the jth-second value. Depending on whether the kth response value rk for the kth question qk is the first value or the second value, a value corresponding to the kth-second correct rate may be determined as the kth-second value, or a value obtained by subtracting the kth-second correct rate from one may be determined as the kth-second value.

Thereafter, P(E|B) may be calculated by multiplying the ith-second value, the jth-second value and the kth-second value.

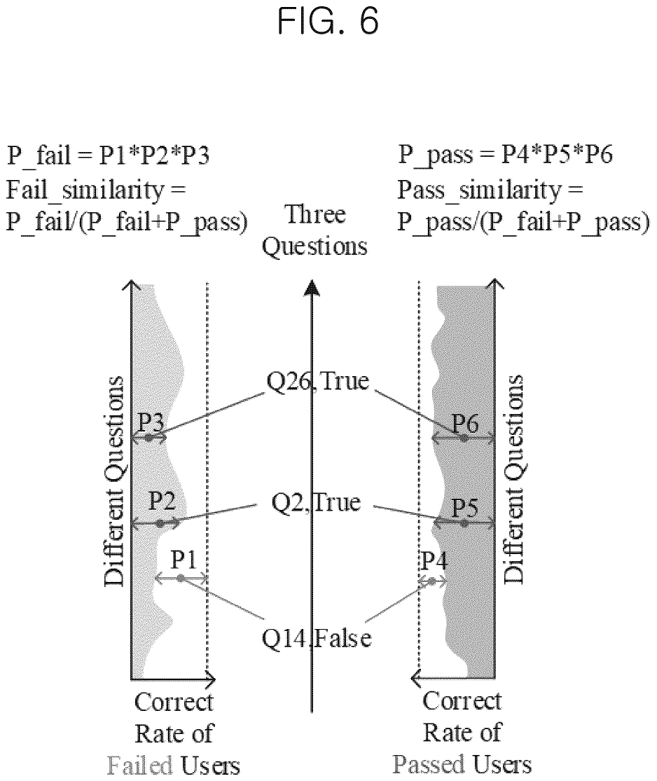

Referring to FIG. 6, an example where M is three, [q2, q14, q26] are selected as reference questions, and [1, 0, 1] are collected as the response data RDAT is illustrated. In other words, in an example of FIGS. 6, i=2, j=14 and k=26, and a second question, a fourteenth question and a twenty-sixth question may be selected as reference questions. In addition, the target user may answer the second question correctly and a second response value may have “1”, the target user may answer the fourteenth question incorrectly and a fourteenth response value may have “0”, and the target user may answer the twenty-sixth question correctly and a twenty-sixth response value may have “1”.

In this example, P(E|A) may be calculated by multiplying a value corresponding to a second-first correct rate, a value obtained by subtracting a fourteenth-first correct rate from one, and value corresponding to a twenty-sixth-first correct rate (e.g., P(E|A)=Pp_q2*(1−Pp_q14)*Pp_q26). P(E|B) may be calculated by multiplying a value corresponding to a second-second correct rate, a value obtained by subtracting a fourteenth-second correct rate from one, and a value corresponding to a twenty-sixth-second correct rate (e.g., P(E|B)=Pf_q2*(1−Pf_q14)*Pf_q26).

In FIGS. 6, Q2, Q14 and Q26 may correspond to the second question, the fourteenth question and the twenty-sixth question, respectively. In addition, P5 may correspond to the second-first correct rate (e.g., Pp_q2), P4 may correspond to the value obtained by subtracting the fourteenth-first correct rate from one (e.g., 1−Pp_q14), P6 may correspond to the twenty-sixth-first correct rate (e.g., Pp_q26), and P_pass may correspond to P(E|A). Similarly, P2 may correspond to the second-second correct rate (e.g., Pf_q2), P1 may correspond to the value obtained by subtracting the fourteenth-second correct rate from one (e.g., 1−Pf_q14), P3 may correspond to the twenty-sixth-second correct rate (e.g., Pf_q26), and P_fail may correspond to P(E|B). Pass_similarity and Fail_similarity may be calculated using P_pass and P_fail, respectively, which may correspond to the first conditional probability (e.g., P(A|E)) and the second conditional probability (e.g., P(B|E)), respectively.

For example, P(E|A) (e.g., P_pass) and P(E|B) (e.g., P_fail), which are calculated as described above, may be substituted into Equation 4, and P(A)=P(B)=0.5 may be applied, and thus P(E)=(P_pass+P_fail)*0.5 may be obtained.

For example, P(E)=(P_pass+P_fail)*0.5 may be substituted into Equation 2 and Equation 3, and thus P(A|E)=P(E|A)*P(A)/P(E)=(P_pass)/(P_pass+P_fail) and P(B|E)=P(E|B)*P(B)/P(E)=(P_fail)/(P_pass+P_fail) may be obtained.

As a result, the first conditional probability (e.g., P(A|E)) may be calculated as (P_pass)/(P_pass+P_fail), and the second conditional probability (e.g., P(B|E)) may be calculated as (P_fail)/(P_pass+P_fail).

Although example embodiments are described based on the case where M is three, example embodiments are not limited thereto. For example, M may be a positive integer greater than three, and the accuracy of prediction may increase as M increases.

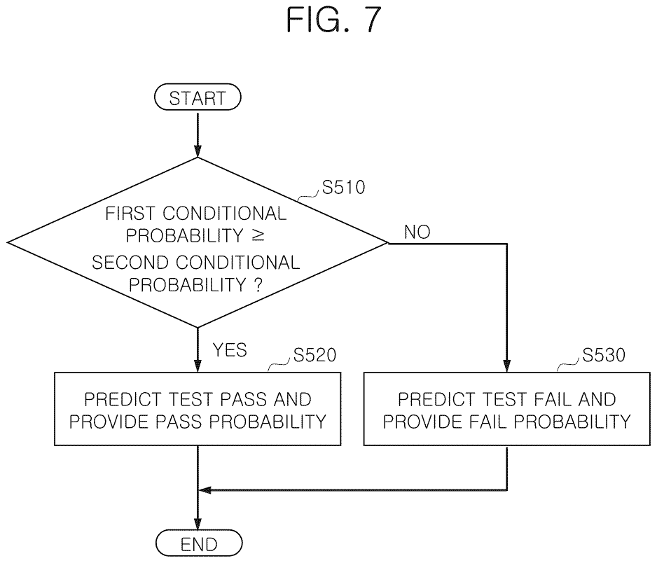

FIG. 7 is a flowchart illustrating an example of generating prediction result of FIG. 1.

Referring to FIGS. 1 and 7, when generating the prediction result representing whether the target user will pass or fail the target test (operation S500), the first conditional probability and the second conditional probability may be compared with each other (operation S510).

When the first conditional probability is greater than or equal to the second conditional probability (operation S510: YES), it may be predicted that the target user will pass the target test, and the pass probability of the target user may be provided (operation S520). In other words, the prediction result may include information that the target user will pass the target test and the pass probability of the target user. For example, the first conditional probability may be provided as the pass probability of the target user.

When the first conditional probability is less than the second conditional probability (operation S510: NO), it may be predicted that the target user will fail the target test, and the fail probability of the target user may be provided (operation S530). In other words, the prediction result may include information that the target user will fail the target test and the fail probability of the target user. For example, the second conditional probability may be provided as the fail probability of the target user.

The example embodiments may be applied to various prediction systems and artificial intelligence systems.

The foregoing is illustrative of example embodiments and is not to be construed as limiting thereof. Although some example embodiments have been described, those skilled in the art will readily appreciate that many modifications are possible in the example embodiments without materially departing from the novel teachings and advantages of the example embodiments. Accordingly, all such modifications are intended to be included within the scope of the example embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of predicting test pass/fail, the method being performed by executing instructions using a processor, the instructions being stored in a non-transitory computer-readable medium, the method comprising:
obtaining, for a target test including first to Nth questions, first user portrait data of first users who passed the target test and second user portrait data of second users who failed the target test, where N is a positive integer greater than or equal to two, the first user portrait data representing first-first to Nth-first correct rates of the first users for the first to Nth questions, the second user portrait data representing first-second to Nth-second correct rates of the second users for the first to Nth questions;
selecting M reference questions from among the first to Nth questions, where M is a positive integer less than N;
collecting response data representing whether answers of a target user for the M reference questions are correct or incorrect, the target user being a user who wants to check whether will pass or fail the target test;
calculating first conditional probability and second conditional probability by performing Bayesian inference based on the first user portrait data, the second user portrait data and the response data, the first conditional probability representing probability that the target user passes the target test based on the response data being collected, the second conditional probability representing probability that the target user fails the target test based on the response data being collected; and
generating prediction result based on the first conditional probability and the second conditional probability, the prediction result representing whether the target user will pass or fail the target test, and
wherein the first conditional probability and the second conditional probability are obtained based on Equation 1 and Equation 2, respectively, as follows:
$$P ( A \vert E ) = P ( E \vert A ) * P ( A ) / P ( E ) \qquad [ Equation 1 ]$$
$$P ( B \vert E ) = P ( E \vert B ) * P ( B ) / P ( E ) \qquad [ Equation 2 ]$$
wherein in Equations 1 and 2, P(A|E) denotes the first conditional probability, P(B|E) denotes the second conditional probability, P(A) denotes probability that pass event occurs in the target test, P(B) denotes probability that fail event occurs in the target test, P(E) denotes probability that the response data occurs, P(E|A) denotes conditional probability that the response data occurs based on the pass event occurring, and P(E|B) denotes conditional probability that the response data occurs based on the fail event occurring.

2. The method of claim 1, wherein M is three, and an ith question, a jth question and a kth question are selected as the reference questions from among the first to Nth questions, where each of i, j and k is a positive integer greater than or equal to one and less than or equal to N,
wherein P(E|A) included in Equation 1 is calculated based on an ith-first correct rate for the ith question, a jth-first correct rate for the jth question and a kth-first correct rate for the kth question among the first-first to Nth-first correct rates, and
wherein P(E|B) included in Equation 2 is calculated based on an ith-second correct rate for the ith question, a jth-second correct rate for the jth question and a kth-second correct rate for the kth question among the first-second to Nth-second correct rates.

3. The method of claim 2, wherein, based on an ith answer value of the target user for the ith question being equal to an ith right answer value for the ith question, an ith response value for the ith question included in the response data has a first value, and
wherein, based on the ith answer value being different from the ith right answer value, the ith response value has a second value different from the first value.

4. The method of claim 3, wherein, based on the ith response value having the first value, a value corresponding to the ith-first correct rate is used to calculate P(E|A) included in Equation 1, and
wherein, based on the ith response value having the second value, a value obtained by subtracting the ith-first correct rate from one is used to calculate P(E|A) included in Equation 1.

5. The method of claim 1, wherein, based on the first conditional probability being greater than or equal to the second conditional probability, the prediction result representing that the target user will pass the target test is generated, and the first conditional probability is provided as pass probability of the target user, and
wherein, based on the first conditional probability being less than the second conditional probability, the prediction result representing the target user will fail the target test is generated, and the second conditional probability is provided as fail probability of the target user.

6. A prediction system comprising:
a processor; and
a non-transitory computer-readable medium configured to store instructions executed using the processor to predict test pass/fail,
wherein the processor is configured, by executing the instructions, to:
obtain, for a target test including first to Nth questions, first user portrait data of first users who passed the target test and second user portrait data of second users who failed the target test, where N is a positive integer greater than or equal to two, the first user portrait data representing first-first to Nth-first correct rates of the first users for the first to Nth questions, the second user portrait data representing first-second to Nth-second correct rates of the second users for the first to Nth questions;
select M reference questions from among the first to Nth questions, where M is a positive integer less than N;
collect response data representing whether answers of a target user for the M reference questions are correct or incorrect, the target user being a user who wants to check whether will pass or fail the target test;
calculate first conditional probability and second conditional probability by performing Bayesian inference based on the first user portrait data, the second user portrait data and the response data, the first conditional probability representing probability that the target user passes the target test based on the response data being collected, the second conditional probability representing probability that the target user fails the target test based on the response data being collected; and
generate prediction result based on the first conditional probability and the second conditional probability, the prediction result representing whether the target user will pass or fail the target test, and
wherein the first conditional probability and the second conditional probability are obtained based on Equation 3 and Equation 4, respectively, as follows:
$$P ( A \vert E ) = P ( E \vert A ) * P ( A ) / P ( E ) \qquad [ Equation 3 ]$$
$$P ( B \vert E ) = P ( E \vert B ) * P ( B ) / P ( E ) \qquad [ Equation 4 ]$$
wherein in Equations 3 and 4, P(A|E) denotes the first conditional probability, P(B|E) denotes the second conditional probability, P(A) denotes probability that pass event occurs in the target test, P(B) denotes probability that fail event occurs in the target test, P(E) denotes probability that the response data occurs, P(E|A) denotes conditional probability that the response data occurs based on the pass event occurring, and P(E|B) denotes conditional probability that the response data occurs based on the fail event occurring.

7. The prediction system of claim 6, wherein M is three, and an ith question, a jth question and a kth question are selected as the reference questions from among the first to Nth questions, where each of i, j and k is a positive integer greater than or equal to one and less than or equal to N,
wherein P(E|A) included in Equation 3 is calculated based on an ith-first correct rate for the ith question, a jth-first correct rate for the jth question and a kth-first correct rate for the kth question among the first-first to Nth-first correct rates, and
wherein P(E|B) included in Equation 4 is calculated based on an ith-second correct rate for the ith question, a jth-second correct rate for the jth question and a kth-second correct rate for the kth question among the first-second to Nth-second correct rates.

8. The prediction system of claim 7, wherein, based on an ith answer value of the target user for the ith question being equal to an ith right answer value for the ith question, an ith response value for the ith question included in the response data has a first value, and
wherein, based on the ith answer value being different from the ith right answer value, the ith response value has a second value different from the first value.

9. The prediction system of claim 8, wherein, based on the ith response value having the first value, a value corresponding to the ith-first correct rate is used to calculate P(E|A) included in Equation 3, and
wherein, based on the ith response value having the second value, a value obtained by subtracting the ith-first correct rate from one is used to calculate P(E|A) included in Equation 3.

10. The prediction system of claim 6, wherein, based on the first conditional probability being greater than or equal to the second conditional probability, the prediction result representing that the target user will pass the target test is generated, and the first conditional probability is provided as pass probability of the target user, and
wherein, based on the first conditional probability being less than the second conditional probability, the prediction result representing the target user will fail the target test is generated, and the second conditional probability is provided as fail probability of the target user.
